(19) United States
(12) Patent Application Publication
(10) Pub. No.: US 2024/0363991 A1
(43) Pub. Date: Oct. 31, 2024

(54) LARGE BALLOON REFLECTOR FOR REMOTE SENSING

(71) Applicant: Arizona Board of Regents on Behalf of the University of Arizona, Tucson, AZ (US)

(72) Inventor: Christopher K. Walker, Tucson, AZ (US)

(21) Appl. No.: 18/650,023

(22) Filed: Apr. 29, 2024

Related U.S. Application Data
(60) Provisional application No. 63/498,921, filed on Apr. 28, 2023.

(51) Int. Cl. H01Q 1/08; B64U 10/60; B64U 101/00; G01C 21/16; H01Q 15/16

(52) U.S. Cl. CPC H01Q 1/082; B64U 10/60; G01C 21/16; H01Q 15/163; B64U 2101/00

(57) ABSTRACT

A large balloon reflector, capable of launching and support itself at high altitudes, with a feed system capable of steering the beam quickly enough to perform target tracking of fast-moving terrestrial, stratospheric, or orbiting objects. The large balloon reflector antenna forms a suborbital antenna system that is suitable for operation from radio to infrared wavelengths and can be used, for example, for remote sensing of objects on the ground, in the atmosphere, or in space.

### CROSS-REFERENCE TO RELATED APPLICATIONS

This application claims priority to U.S. Prov. Pat. Appl. No. 63/498,921, filed Apr. 28, 2023, which is hereby incorporated by reference in its entirety.

### FEDERAL FUNDING

None

### BACKGROUND

Existing balloon reflector antennas (e.g., as described below with reference to FIG. 1) include a transparent surface opposite a reflective surface. Electromagnetic waves pass through the transparent surface and are reflected off the reflective surface of the balloon reflector. A feed system inside the balloon reflector antenna—for example, a pivoting line feed, a phased array line feed, a feedhorn, a planar antenna, a spherical corrector (e.g., a quasi-optical spherical corrector), etc.—receives or emits the electromagnetic waves. Balloon reflector antennas provide a high gain antenna at a fraction of the weight of conventional antennas, significantly reducing the cost to lift them to high altitudes (e.g., into the stratosphere or space). Meanwhile, balloon reflector antennas can perform beam steering without repositioned the entire structure (e.g., spacecraft or ballooncraft), reducing the size, weight, and cost to manufacture and deploy the system.

There is a desire for a balloon reflector antenna with an effective aperture larger than 5 meters and capable of supporting itself at high altitudes (e.g., greater than 60,000 feet)

NASA's zero pressure and super pressure balloons can have a diameter D_{B} of about 146 meters, allowing balloon reflector diameters D_{R} of up to D_{B}/10 (approximately 15 meters) to be realized. However, while existing balloon reflector feed systems are capable of slowly steering a beam for astronomical observations, existing feed systems are incapable of steering the beam of a large balloon reflector quickly enough to perform target tracking of fast-moving terrestrial, stratospheric, or orbiting objects (e.g., ground vehicles, ships, aircraft, or low orbiting satellites).

Accordingly, there is a desire for a large, near space (i.e., stratospheric) balloon reflector antenna of diameter D_{R} with a feed system capable of steering the beam within the associated balloon of diameter D_{B} quickly enough to perform target tracking of fast-moving terrestrial, stratospheric, or orbiting objects.

### SUMMARY

In order to overcome those and other drawbacks of the prior art, disclosed is a large balloon reflector, capable of launching and support itself at high altitudes, with a feed system capable of steering the beam quickly enough to perform target tracking of fast-moving terrestrial, stratospheric, or orbiting objects. The large balloon reflector antenna forms a suborbital antenna system, suitable for operation from radio to infrared wavelengths, that can be used for remote sensing of objects on the ground, in the atmosphere, or in space.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1 is a diagram illustrating a satellite with a prior art balloon reflector antenna.

FIG. 2 is a diagram illustrating a large balloon reflector antenna according to exemplary embodiments.

FIG. 3 is a block diagram illustrating the large balloon reflector antenna of FIG. 2 according to exemplary embodiments.

FIG. 4 is a diagram illustrating an optics module according to an exemplary embodiment.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

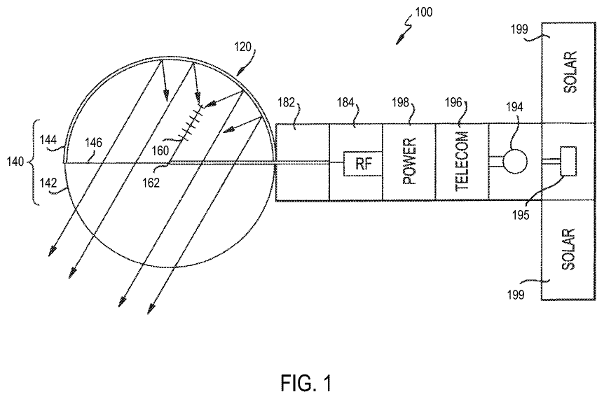

FIG. 1 is a diagram illustrating a satellite 100 with a prior art balloon reflector antenna 120.

In the example of FIG. 1, the balloon reflector antenna 120 includes a spherical balloon 140 having a transparent surface 142 opposite a reflective surface 144 (and one or more optional dielectric support curtains 146 to help the balloon 140 keep its spherical shape) and a feed system 160. The satellite 100 also includes a balloon reflector canister 182 for stowing the uninflated balloon 140 during launch, an RF module 184 for sending and/or receiving signals via the feed system 160, a pitch reaction wheel 194 and a roll reaction wheel 195 for steering the satellite 100, a telecommunications module 196 enabling the satellite to receive command and control signals (e.g., via the balloon reflector antenna 120), solar panels 199, and a power module 198 for storing power received from the solar panels 199 and providing power to various components of the satellite 100.

When the balloon reflector antenna 120 receives a signal (e.g., from the ground), the signal passes through the transparent surface 142 and encounters the reflective surface 144, which focuses the signal into the feed system 160. When the balloon reflector antenna 120 transmits a signal (e.g., to the ground), the signal is emitted by the feed system 160 and encounters the reflective surface 144, which directs the signal through the transparent surface 142. In the example of FIG. 1, the feed system 160 is a pivoting line feed extending from the center of the balloon 140 with a motorized mount 162 that pivots the feed system 160 to steer the antenna beam.

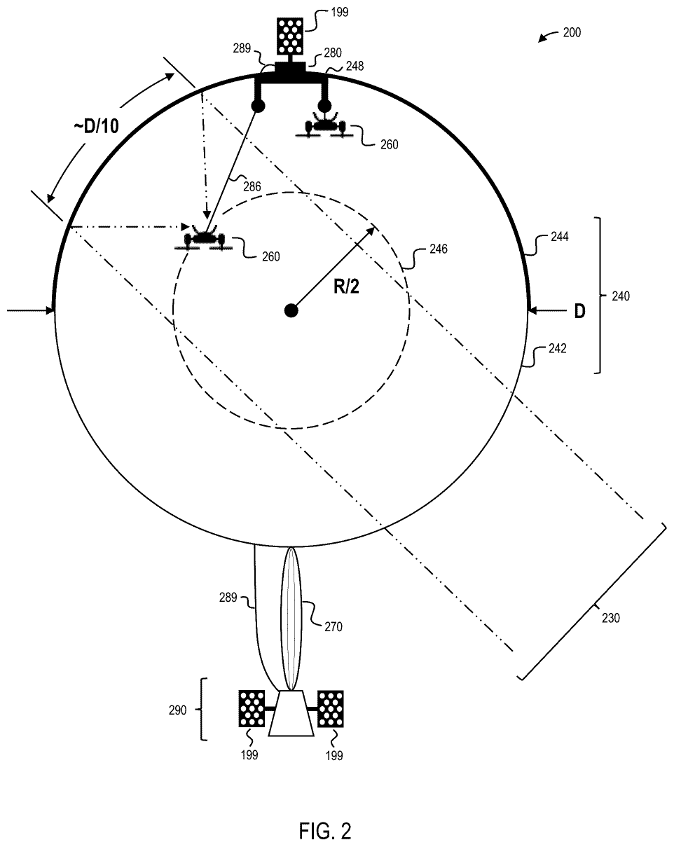

FIG. 2 is a diagram illustrating a large balloon reflector antenna 200 according to exemplary embodiments.

In the embodiment of FIG. 2, the large balloon reflector antenna 200 includes a large balloon 240 having a top plate 248, an electronics module 280 supported by the top plate 248, and a service gondola 290 suspended from the large balloon 240. Each of the electronics module 280 and/or the service gondola 290 may include one or more solar panels 199. The electronics module 280 and the service gondola 290 may communicate wirelessly (e.g., using a 5G wireless signal) and/or via one or more wires 289. One or more wires 289 may also be used to provide power from the service gondola 290 to the electronics module 280 (or vice versa).

Similar to the balloons 140 of the prior art balloon reflector antennas 120 described above, the large balloon 240 has a transparent surface 242 opposite a near-spherical reflective surface 244, enabling the large balloon reflector antenna 200 to receive signals 230 that pass through the transparent surface 242 and are reflected by the reflective surface 244 (as shown in FIG. 2) and/or transmit signals 230 that are reflected by the reflective surface 244 and pass through the transparent surface 242.

Unlike those prior art balloon reflector antennas 120, however, the large balloon 240 is large enough to lift and support the large balloon reflector antenna 200 to high altitudes (e.g., to near space). For example, the large balloon 240 may be a helium balloon having a diameter D of approximately 146 meters. The transparent surface 242 may be, for example, a polyethylene skin (e.g., with a thickness of approximately 1 mil). The reflective surface 244 may be formed, for example, by aluminizing one hemisphere of the balloon 240.

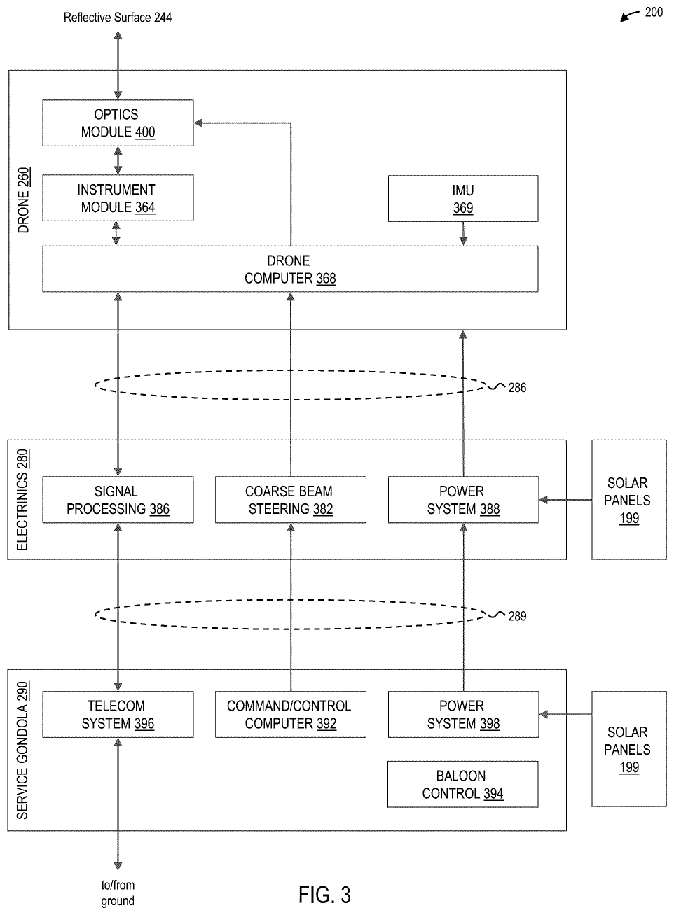

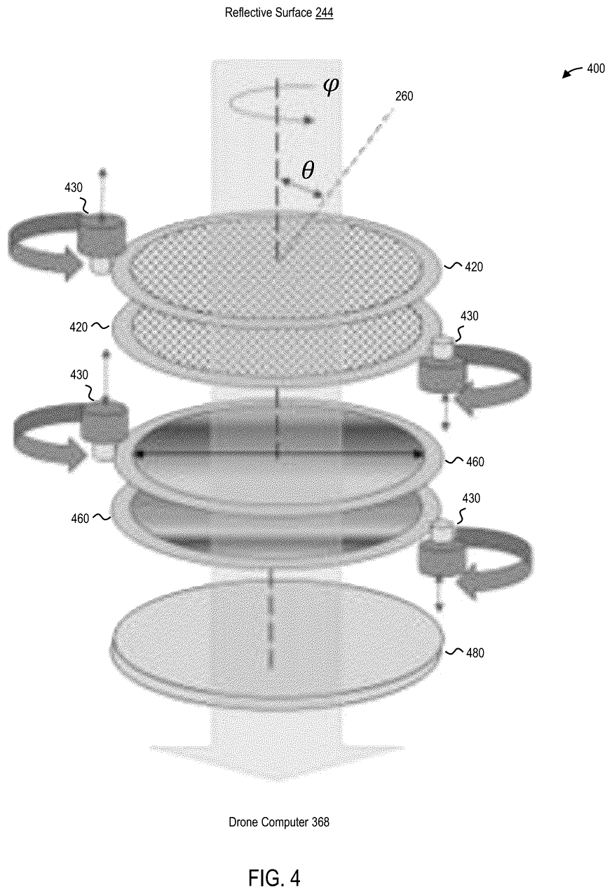

The near-spherical reflective surface 244 forms a spherical focal surface 246 located at ½ of the radius R of the balloon 240. To sample signals 230 over the focal surface 246 (and/or emit signals 230 from the focal surface 246), the large balloon reflector antenna 200 includes one or more drones 260 (i.e., unmanned aerial vehicles) inside the balloon 240 that, as described in detail below with reference to FIGS. 3 and 4, are each outfitted with a transmission/detection system. Each drone 260 is connected to the electronics module 280 by a retractable tether 286, increasing the stability of the drone 260 and enabling wired and secure communication from the drone 260 to the electronics module 280.

The lift capacity of drones 260 is severely diminished within the large balloon 240, due to the lower atmospheric pressure (which is, for example, approximately 100 times lower at 100,000 feet than at sea level) and helium environment (which is 7.2 times lower than air). In all, the lift capacity of each drone 260 is reduced by a factor of about 720 as compared to what it would have in a normal atmosphere at sea level. Accordingly, each retractable tether 286 provides power to the drone 260, eliminating the need for each drone 260 to include and lift a battery and enabling each drone 260 to have the lift capacity to position itself within the low-pressure, low-density helium environment within the large balloon 240.

The transmission/detection system of each drone may be millimeter-wave receivers. In embodiments that include more than one drone 260, each transmission/detection system may operate at a different center frequency.

The transmission/detection systems of each drone 260 can operate at gigahertz to terahertz frequencies. Accordingly, the large balloon reflector antenna 200 forms an antenna system that can be used for radio-frequency imaging, frequency-modulated continuous wave radar (e.g., for target Doppler tracking, chemical analysis of target vapors, etc.), etc. The antenna system can be remotely steered from the ground or perform any of the autonomous control methods that are known in the art, such as searching (e.g., a spiral search) for a particular target (e.g., a chemical signature), target tracking, etc. The service gondola 290 communicates with the ground, for example via a satellite network (e.g., the Tacking and Data Relay Satellite (TDRS) system, the Iridium satellite constellation, Starlink constellation, etc.). The large balloon reflector antenna 200 can stay aloft for approximately 100 days. The large balloon reflector antenna 200 can maintain a position over a certain area (e.g., station keeping) by changing altitude and utilizing high altitude winds as is known in the art. The large balloon reflector antenna 200 may include a one or more parachutes 270 to aid in recovery of the drones 260, the electronics module 280, and/or the service gondola 290.

By positioning a drone 260 over the spherical focal surface 246, the disclosed large balloon reflector antenna 200 provides a phenomenal field of view (similar to a 15-meter parabolic reflector): nearly +90 degrees in the direction perpendicular to the reflective surface 244 and 360 degrees in the direction parallel to the reflective surface 244. In the embodiment of FIG. 2, the reflective surface 244 is formed on the top hemisphere of the balloon 240, enabling the large balloon reflector antenna 200 to send and receive signals 230 to and from the ground (and/or remotely sense objects on the ground). In other embodiments, the reflective surface 244 may be formed on the bottom hemisphere of the balloon 240 (enabling the large balloon reflector antenna 200 to communicate with and/or sense objects in space) or a side of the balloon 240 (enabling the large balloon reflector antenna 200 to have a field of view of nearly ±90 degrees in the elevation direction).

FIG. 3 is a block diagram of the large balloon reflector antenna 200 according to exemplary embodiments.

In the embodiment of FIG. 3, the service gondola 290 includes a command and control computer 392, a telecommunications system 396 for communicating with the ground, a balloon control module 394, and a power system 398; the electronics module 280 includes a signal processing module 386, a coarse beam steering module 382, and a power system; and each drone 260 includes an optics module 400 (described in detail below with reference to FIG. 4), an instrument module 364, a drone computer 368, and an internal measurement unit 369.

In the embodiment of FIG. 3, the power system 398 of the service gondola 290 provides power to the electronics module 280 via a wire 289, which provides power to the drone 260 via the retractable tether 268. To coarse steer the beam 230, the electronics module 280 outputs control signals to position the drone 260 along the focal surface 246 as described above. The position of a tethered drone 260 may be determined (with accuracy of several centimeters) based on the length and angular position of the tether 286 relative to its reel and the expected slack in the tether 286 due to its weight and length). Meanwhile, as described below with reference to FIG. 4, the drone 260 may electronically steer the beam 230 (i.e., fine steering) to compensate for any jitter caused by unintentional movement of the drone 260. For example, each drone 260 may include an inertial measurement unit (IMU) 369 and may electronically steer the beam 230 to compensate for movement of the drone detected by the IMU 369.

FIG. 4 is a diagram of an optics module 400 according to an exemplary embodiment.

In the embodiment of FIG. 4, the optics module 400 includes a quarter wave plate 480, a pair of rotatable Zernike plates 460, and a pair of rotatable phase plates 420. The rotation of each Zernike plate 460 and phase plates 420 is controlled by an individual stepper motor 430, which are each controlled by the drone computer 368. The Zernike plates 460 are rotated to correct for aberrations (e.g., astigmatism) due to the non-ideal shape of the reflective surface 244 (as described, for example, in Chen et al., 2013, “Reconfigurable optical null based on counterrotating Zernike plates for test of aspheres”, Optics Express, Vol. 22, No. 2., p. 1381). In the embodiment of FIG. 4, the phase plates 420 are rotated to finely steer the beam 260 through +60 degrees elevation θ and 360 degrees azimuth φ (as described, for example, in Gagnon N. and Petosa A., 2013, “Using Rotatable Planar Phase Shifting Surfaces to Steer a High-Gain Beam”, IEEE Trans. On Antennas & Propagation, vol. 61, No. 6., p. 3086). In other embodiments, a phased array may be used to finely steer the beam 260.

Referring back to FIG. 3, signals 230 to or from the reflective surface 244 are corrected by the optics module 400 and passed to or from the drone computer 368 via an instrument module 364. Depending on the particular application of the large balloon reflector antenna 200, the instrument module 364 may include any passive (e.g., thermal imaging) or active (e.g., chirp radar) transmission/detection system.

While preferred embodiments have been described above, those skilled in the art who have reviewed the present disclosure will readily appreciate that other embodiments can be realized within the scope of the invention. While preferred embodiments have been described above, those skilled in the art who have reviewed the present disclosure will readily appreciate that other embodiments can be realized within the scope of the invention. Accordingly, the present invention should be construed as limited only by any appended claims.

What is claimed is:

1. A balloon reflector antenna, comprising:
a balloon having a transparent surface opposite a reflective surface; and
an unmanned aerial vehicle, inside the balloon, having a detection system configured to capture electromagnetic waves that pass through the transparent surface and are reflected off the reflective surface.

2. The balloon reflector antenna of claim 1, wherein:
the reflective surface forms a spherical focal surface; and
the beam of the balloon reflector antenna is steered by positioning the unmanned aerial vehicle along the spherical focal surface.

3. The balloon reflector antenna of claim 1, further comprising:
an electronics module comprising a battery, a computer, and telecommunications equipment; and
a retractable tether that couples the unmanned aerial vehicle to the electronics module and provides power to the unmanned aerial vehicle.

4. The balloon reflector antenna of claim 3, wherein the retractable tether enables wired and secure communication from the unmanned aerial vehicle to the electronics module.

5. The balloon reflector antenna of claim 3, further comprising:
a service gondola in wired or wireless communication with the electronics module, that communicates with the ground.

6. The balloon reflector antenna of claim 5, wherein the service gondola communicates with the ground via satellite network.

7. The balloon reflector antenna of claim 1, wherein the unmanned aerial vehicle includes an optics module for correcting aberrations due to the shape of the balloon reflector.

8. The balloon reflector antenna of claim 7, wherein the optics module comprises two rotatable Zernike plates.

9. The balloon reflector antenna of claim 8, wherein:
the unmanned aerial vehicle includes an inertial measurement unit that outputs data indicative of the movement of the unmanned aerial vehicle; and
the unmanned aerial vehicle compensates for movement of the unmanned aerial vehicle by fine steering a beam in response to the data output by the inertial measurement unit.

10. The balloon reflector antenna of claim 9, wherein the optics module comprises two rotatable phase plates for fine steering the beam.

11. A method, comprising:
providing a balloon having a transparent surface opposite a reflective surface; and
positioning an unmanned aerial vehicle having a detection system inside the balloon; and
capturing electromagnetic waves that pass through the transparent surface and are reflected off the reflective surface by the detection system.

12. The method of claim 11, wherein the reflective surface forms a spherical focal surface, the method further comprising:
steering the beam of the balloon reflector antenna by positioning the unmanned aerial vehicle along the spherical focal surface.

13. The method of claim 11, further comprising:
providing power to the unmanned aerial vehicle, from an electronics module attached to a top plate of the balloon, via a retractable tether that couples the unmanned aerial vehicle to the electronics module.

14. The method of claim 13, wherein the retractable tether enables wired and secure communication from the unmanned aerial vehicle to the electronics module.

15. The method of claim 13, further comprising:
communicating with the ground via a service gondola in wired or wireless communication with the electronics module.

16. The method of claim 15, wherein the service gondola communicates with the ground via satellite network.

17. The method of claim 11, further comprising:
correcting aberrations due to the shape of the balloon reflector.

18. The method of claim 17, wherein the aberration correction is performed by two rotatable Zernike plates.

19. The method of claim 18, wherein:
capturing data indicative of the movement of the unmanned aerial vehicle by an inertial measurement unit; and
fine steering a beam in response to the data output by the inertial measurement unit.

20. The method of claim 9, wherein the fine steering is performed by two rotatable phase plates.
